(19) United States
(12) Patent Application Publication
(10) Pub. No.: US 2026/0075494 A1
(43) Pub. Date: Mar. 12, 2026

(54) SYSTEMS AND METHODS FOR PROVIDING CONDITIONAL TRIGGERED MOBILITY FOR A USER EQUIPMENT

(71) Applicant: Verizon Patent and Licensing Inc., Basking Ridge, NJ (US)

(72) Inventors: Vishwanath RAMAMURTHI, San Ramon, CA (US); Wei David HUANG, Danville, CA (US)

(73) Assignee: Verizon Patent and Licensing Inc., Basking Ridge, NJ (US)

(21) Appl. No.: 18/883,098

(22) Filed: Sep. 12, 2024

(51) Int. Cl. H04W 36/36; H04W 56/00

(52) U.S. Cl. CPC H04W 36/362; H04W 56/0045

(57) ABSTRACT

A source network device may receive measurement data associated with a user equipment (UE) in a network, and may generate handover conditions for handing over the UE to a target network device in the network. The source network device may generate a handover request based on the measurement data satisfying the handover conditions, and may provide the handover request to initiate handover to the target network device. The source network device may apply a targeted configuration to the UE before the handover of the UE to the target network device, and may enable downlink synchronization and timing advance acquisition with the target network device before the handover of the UE to the target network device. The source network device may receive a handover success message from the target network device following completion of the handover.

### BACKGROUND

The telecommunications industry continually seeks to improve user experience in mobile networks, especially with services such as extended reality (XR), which includes augmented reality (AR) and virtual reality (VR). These services demand high throughput while maintaining low latency and high reliability, which can be particularly challenging in mobile scenarios where a user equipment (UE) may be in motion, moving from one coverage area to another.

### BRIEF DESCRIPTION OF THE DRAWINGS

FIGS. 1A-1F are diagrams of an example associated with providing conditional triggered mobility for a user equipment (UE).

FIG. 2 is a diagram of an example environment in which systems and/or methods described herein may be implemented.

FIG. 3 is a diagram of example components of one or more devices of FIG. 2.

FIG. 4 is a flowchart of an example process for providing conditional triggered mobility for a UE.

### DETAILED DESCRIPTION OF EXAMPLE EMBODIMENTS

The following detailed description of example implementations refers to the accompanying drawings. The same reference numbers in different drawings may identify the same or similar elements.

To address the challenges associated with services that demand high throughput, low latency, and high reliability, the telecommunications industry has introduced mechanisms such as conditional handover (CHO) and Layer 1/Layer 2 triggered mobility (LTM). CHO improves handover reliability and slightly reduces handover latency by configuring handover conditions at a source network device (e.g., a base station) based on Layer 3 (L3) measurements and allowing a user equipment (UE) to execute handover without communication with the source network device under deteriorating radio link conditions. Despite these advances, handover latency remains high for CHO implementations. On the other hand, LTM seeks to reduce handover latency and interruption time by allowing certain preparations for target cells (e.g., target base stations) in advance, such as downlink and uplink synchronization. While LTM enhances handover speed by using preconfigured cells, LTM has reliability issues since commands can be lost and Layer 1 (L1) measurements can be unreliable.

Thus, current techniques for handling handovers of UEs utilizing services that demand high throughput, low latency, and high reliability consume computing resources (e.g., processing resources, memory resources, communication resources, and/or the like), networking resources, and/or other resources associated with failing to optimize both handover latency and handover reliability for UEs utilizing the services that demand high throughput, low latency, and high reliability, failing to address the handover process in different network configurations (e.g., a aggregated base station handovers, intra-base station handovers, inter-base station handovers, disaggregated base station handovers, and/or the like), handling poor user experiences based on failing to optimize both handover latency and handover reliability for UEs utilizing the services that demand high throughput, low latency, and high reliability, and/or the like.

Some implementations described herein relate to a source network device (e.g., a base station) that provides conditional triggered mobility for a UE. For example, the source network device may receive measurement data associated with a user equipment (UE) in a network, and may generate handover conditions for handing over the UE to a target network device in the network. The source network device may generate a handover request based on the measurement data satisfying the handover conditions, and may provide the handover request to initiate handover to the target network device. The source network device may apply a targeted configuration to the UE before the handover of the UE to the target network device, and may enable early downlink synchronization and timing advance acquisition with the target network device before the handover of the UE to the target network device. The source network device may receive a handover success message from the target network device following completion of the handover.

In this way, a source network device provides conditional triggered mobility for a UE. For example, the source network device may enhance handover reliability and reduce handover latency/interruption time in telecommunications networks. The source network device may receive measurement data from a UE and may generate handover conditions based on the measurement data. The source network device may provide a handover request, including an identifier of a target network device, to initiate handover without radio access channel procedures. The source network device may apply a targeted configuration to the UE, incorporating both Layer 1 and Layer 3 measurements specific to the target network device. The source network device may enable early downlink and uplink synchronization, as well as timing advance acquisition with the target network device before the handover. By ensuring a more efficient handover procedure, a network may provide consistent service quality required by latency-sensitive applications, and may accommodate a higher volume of such high-quality connectivity demands without additional resources.

Thus, the source network device may conserve computing resources, networking resources, and/or other resources that would have otherwise been consumed by failing to optimize both handover latency and handover reliability for UEs utilizing the services that demand high throughput, low latency, and high reliability, failing to address the handover process in different network configurations (e.g., a aggregated base station handovers, intra-base station handovers, inter-base station handovers, disaggregated base station handovers, and/or the like), handling poor user experiences based on failing to optimize both handover latency and handover reliability for UEs utilizing the services that demand high throughput, low latency, and high reliability, and/or the like.

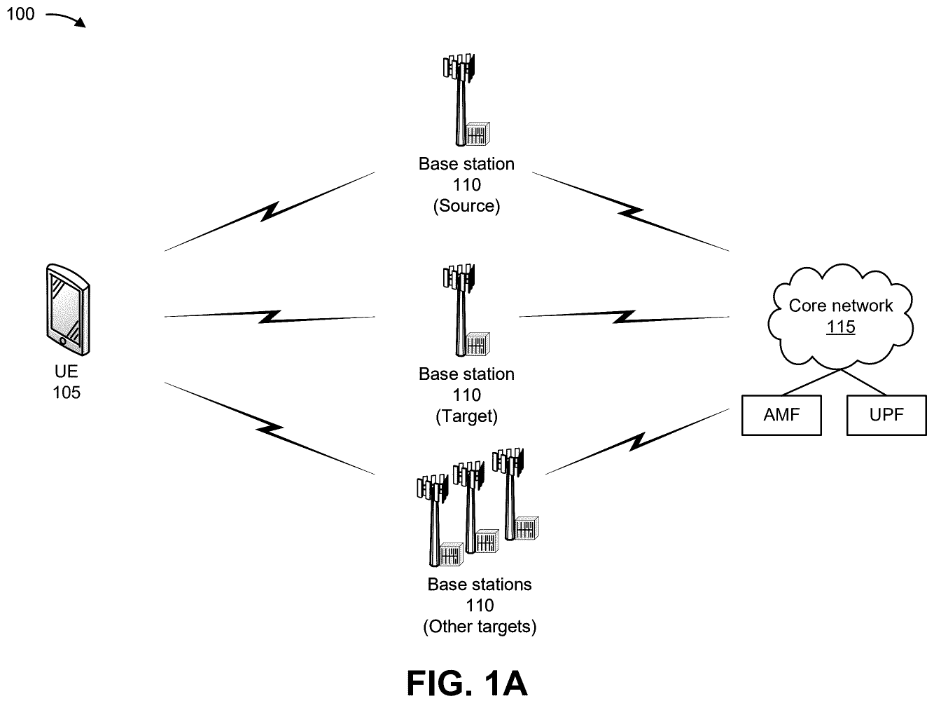

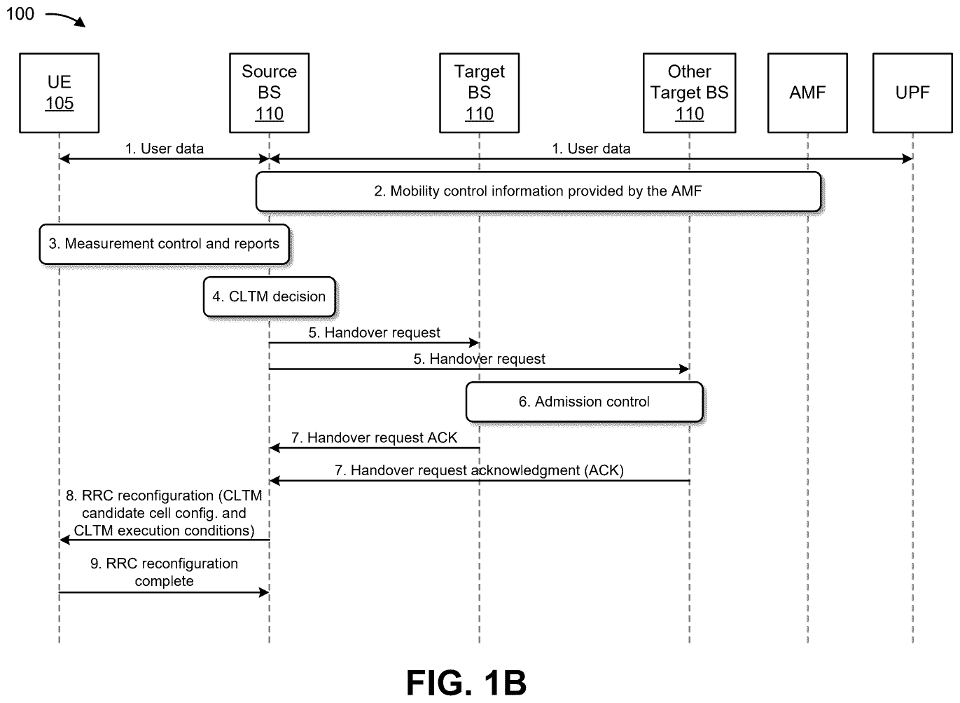

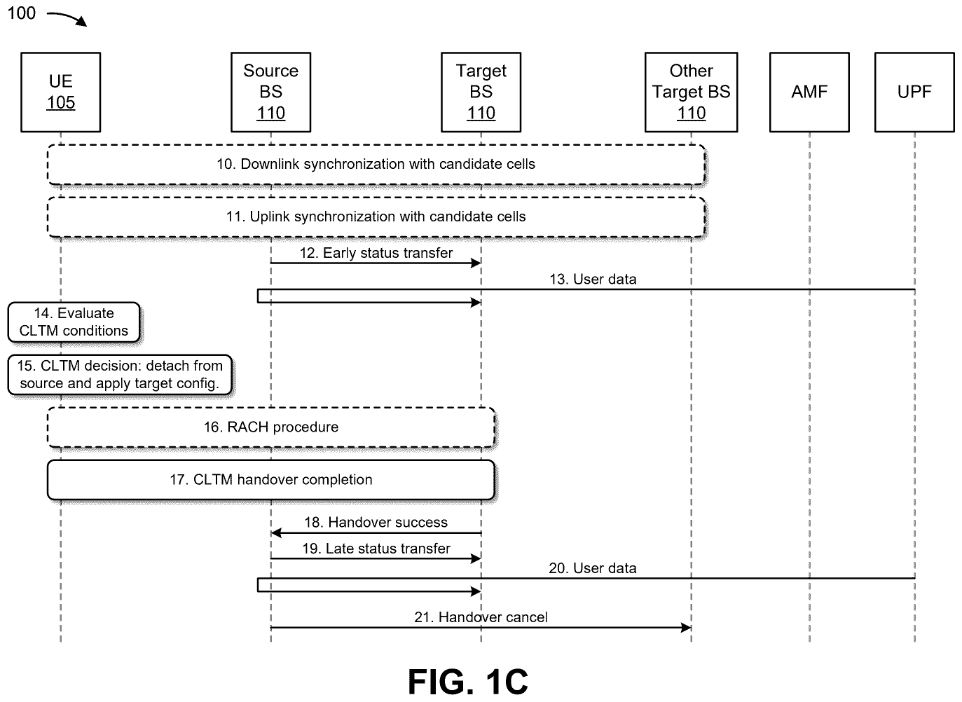

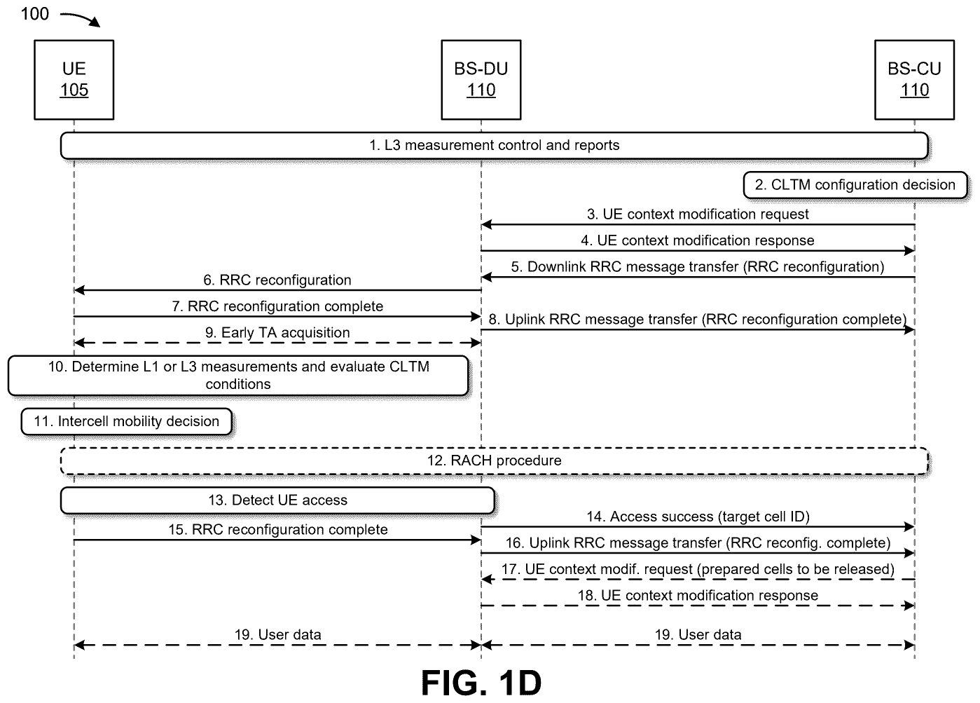

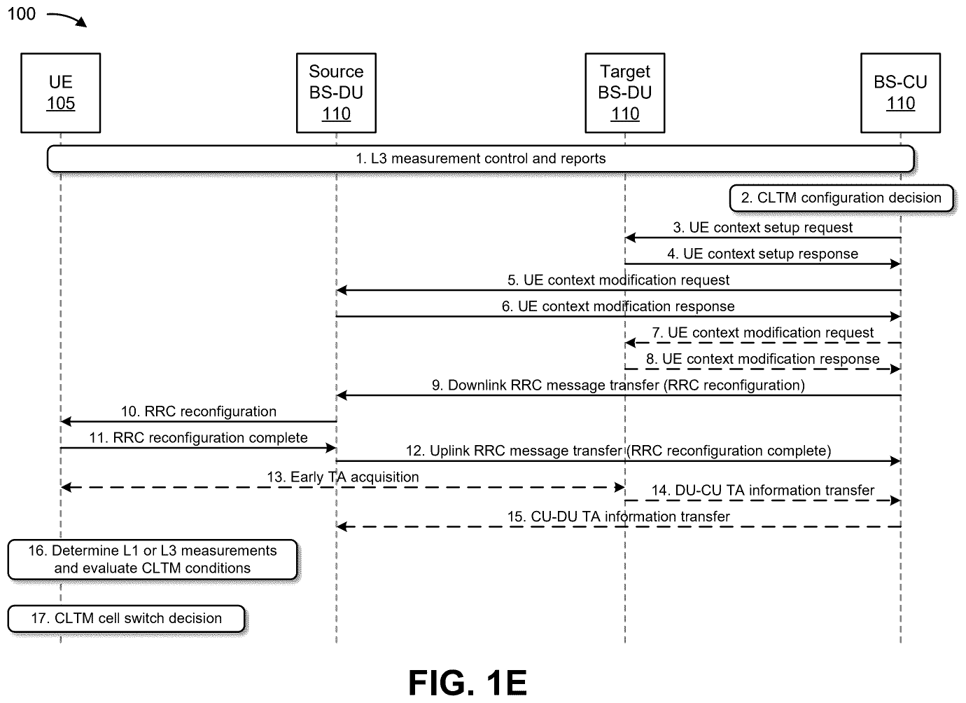

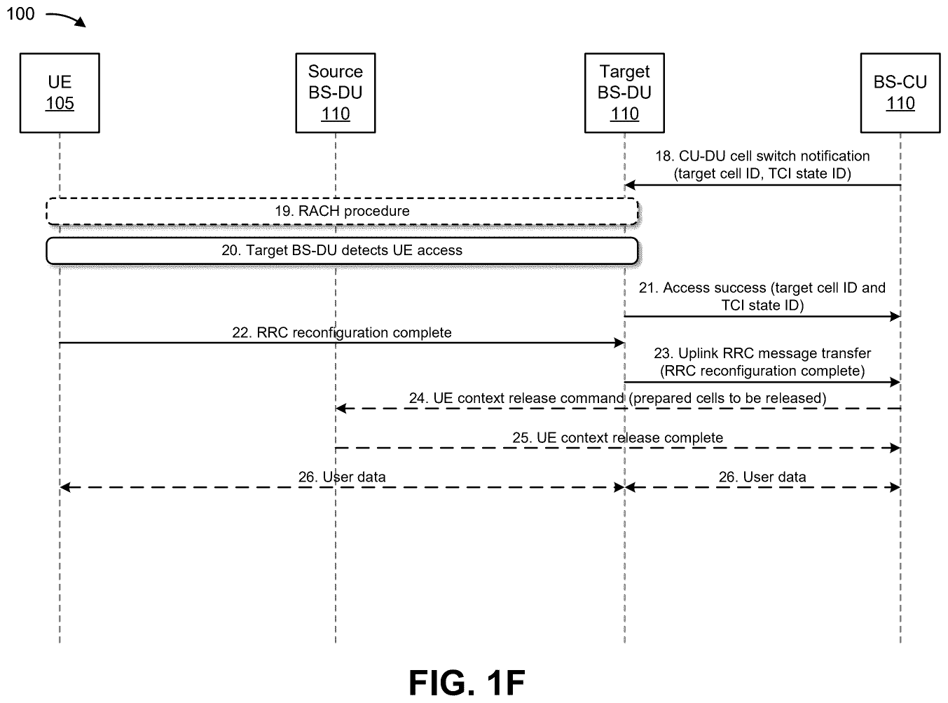

FIGS. 1A-1F are diagrams of an example 100 associated with providing Conditional Layer 1 (L1)/Layer 2 (L2) Triggered Mobility (CLTM) for a UE. As shown in FIGS. 1A-1F, example 100 includes a UE 105, a source base station 110, a target base station 110, other target base stations 110, and a core network 115 that includes an access and mobility management function (AMF) and a user plane function (UPF). Further details of the UE 105, the base stations 110, the core network 115, the AMF, and the UPF are provided elsewhere herein.

As shown in FIG. 1A, the UE 105 may be connected to the source base station 110 and may be utilizing a service (e.g., an augmented reality (AR) service, a virtual reality service (VR) service, and/or the like) provided by the core network 115 via the source base station 110. However, the UE 105 may move to a location that is a first distance from the source base station 110 and that is a second distance from the target base station 110 and/or the other target base stations 110, where the first distance may be greater than the second distance. This may cause a network connectivity between the UE 105 and the source base station 110 to deteriorate, and may cause a network connectivity between the UE 105 and the target base station 110 and/or the other target base stations 110 to improve. Thus, the UE 105 may benefit from being handed over to the target base station 110 or one of the other target base stations 110 to provide a better connection with the core network 115 and improved user experience for the service. The service being provided relies on the effective and efficient handover of the UE 105 between base stations 110 to maintain service quality. CLTM may be used to enhance handover reliability while reducing handover latency for the UE.

In some implementations, the source base station 110 may evaluate trajectory movement patterns of the UE 105 to predict potential handover scenarios prior to initiating handover. This predictive evaluation enables the source base station 110 to anticipate future locations of the UE 105 and prepares for potential changes in connectivity. Additionally, or alternatively, the source base station 110 may perform a proactive handover to the target base station 110 if predictive models indicate an impending deterioration of connectivity. This may reduce the chances of service interruption by transferring the UE 105 to a better-suited base station 110 based on the predicted trajectory.

In some implementations, handover decisions may be based on historical data and expected behavior of the UE 105 within the network. Utilizing such historical data can help to create a more resilient and efficient handover by aligning with typical patterns and service needs of the UE 105. Additionally, or alternatively, a handover request provided to the UE 105 may be configured to initiate a direct switch to the target base station 110 if certain predefined thresholds of signal quality are satisfied. This may minimize delay and ensure a high-quality connection for services requiring robust performance.

FIGS. 1B and 1C depict an example information flow diagram associated with providing CLTM for the UE 105. As shown at step 1 of the FIG. 1B, the UE 105 may exchange user data with the UPF of the core network 115, via the source base station (BS) 110. For example, the UE 105 may receive the user data (e.g., a service, such as an AR service or a VR service) from the UPF via the source base station 110. As shown at step 2, the source base station 110 may receive, from the AMF of the core network 115, mobility control information associated with the UE 105. For example, the AMF is a control plane function in the core network 115 that manages connections and mobility. The AMF may establish and release control plane signaling connections between the UE 105 and the AMF, may ensure that the UE 105 is always reachable, and may provide mobility management by tracking a location of the UE 105 and managing handovers of the UE 105 between base stations 110. The source base station 110 may receive the mobility management information generated by the AMF when tracking the location of the UE 105.

As shown at step 3, the source base station 110 may receive measurement control and reports from the UE 105. For example, the source base station 110 may collect L3 measurements associated with the UE 105 to facilitate monitoring and assessing the communication and reception characteristics of the UE 105. In some implementations, the source base station 110 may collect L1 measurements from the UE 105 (e.g., which include signal strength indicators such as a reference signal received power (RSRP) or a reference signal received quality (RSRQ)) to support the handover decision-making process. Additionally, or alternatively, the source base station 110 may utilize use a combination of L1 and L3 measurements to generate a more precise handover decision-making process. The combination of these measurements may enable the source base station 110 to tailor the handover strategy to the specific needs and current conditions of the UE 105, thus ensuring a smoother transition between base stations 110. Additionally, or alternatively, instead of solely relying on pre-configured handover conditions, the source base station 110 may dynamically adjust the handover conditions based on real-time network data or predictive analytics. This adaptive approach enables the network to react to sudden changes in the environment or a behavior of the UE 105, thereby maintaining optimal performance and connectivity for the UE 105.

As shown at step 4, the source base station 110 may determine a CLTM decision. For example, the source base station 110 may apply a model algorithm or set of criteria based on the received measurements to generate handover conditions, which may include parameters for downlink/uplink synchronization, timing advance acquisition, and configurations for L1-based measurements that are specified with configurable types and trigger conditions.

A shown at step 5, the source base station 110 may provide handover requests to the target base station 110 and the other target base stations 110 based on the CLTM decision. For example, the handover requests provided to the target base station 110 and the other target base stations 110 may include parameters, such as quality of service (QoS) requirements of the UE 105 or specific configuration requests for the target base station 110, to ensure a handover that preserves service continuity. These details define expectations for the target base station 110 regarding a service level that the UE 105 is to receive post-handover. Additionally, or alternatively, the handover request may include a request for early downlink synchronization signals and timing configurations for the target network devices 110 to facilitate a rapid and smooth handover process. Early downlink synchronization signals and appropriate timing adjust the UE 105 to quickly align with operations of the target network devices 110, reducing the risk of communication gaps before handover.

As shown at step 6, the target base station 110 and the other target base stations 110 may perform, based on the handover request, an admission control procedure to determine whether to accept the handover request. For example, during the admission control procedure, the target base stations 110 may consider not only capacity and resource availability but also a current load and anticipated future demands to ensure optimal network performance post-handover. By taking into account a wider spectrum of factors, the target base stations 110 can make more informed decisions about whether to accept the handover request. As shown at step 7, the source base station 110 may receive handover request acknowledgments from the target base station 110 and the other target base stations 110. For example, the handover request acknowledgments from the target base stations 110 may include a proposed timing for the handover or suggested modifications to the handover parameters to better accommodate a transition of the UE 105. Such proactive communication allows for a more collaborative and fine-tuned handover process, where the source base station 110 and the target base stations 110 collaborate to optimize a network experience for the UE 105.

As shown at step 8, the source base station 110 may provide, to the UE 105, a radio resource control (RRC) reconfiguration message that includes a list of CLTM candidate cells (e.g., the target base station 110 and the other target base stations 110), CLTM execution conditions, a handover request, configuration information to facilitate early downlink and uplink synchronization (e.g., DL state activation configuration information and UL configuration information), and measurement information (e.g., L1 or L3 and measurement information). For example, the source base station 110 may generate RRC reconfiguration message and may provide the RRC reconfiguration message to the UE 105. The RRC reconfiguration message may include additional control instructions, such as beamforming directions or power control settings, tailored to a predicted trajectory or mobility pattern of the UE 105. By including such parameters, the network can guide the UE 105 with precision, ensuring that the UE 105 utilizes resources optimally and maintains a robust connection throughout mobility in the network.

As shown at step 9, the source base station 110 may receive, from the UE 105, an indication that the RRC reconfiguration is complete. For example, the UE 105 may receive the RRC reconfiguration message and may reconfigure the UE 105 based on the RRC reconfiguration message. Upon reconfiguring the UE 105, an indication that the RRC reconfiguration is complete may be generated by the UE 105 and provided to the source base station 110. Upon receiving the indication that the RRC reconfiguration is complete, the source base station 110 may initiate proactive data forwarding to the target base station 110, reducing the chances of data loss or delays during the actual handover phase.

As shown at step 10 in FIG. 1C, the UE 105 may perform a downlink synchronization with the candidate cells (e.g., the target base station 110 and the other target base stations 110). For example, the downlink synchronization may include the candidate cells receiving dedicated synchronization signals from the source base station 110 prior to the handover. These dedicated synchronization signals enable the UE 105 to acquire accurate timing information from the source base station 110, thus facilitating a smoother handover process. Additionally, or alternatively, the downlink synchronization may include the UE 105 obtaining synchronization by decoding broadcast channel information from the candidate cells. This alternative method of synchronization may enable the UE 105 to independently acquire necessary timing information without the need for dedicated signals, which can be beneficial in networks where such dedicated signals cannot be provided due to bandwidth constraints or specific network configurations.

As shown at step 11, the UE 105 may perform an uplink synchronization with the candidate cells (e.g., the target base station 110 and the other target base stations 110). For example, the uplink synchronization may be facilitated by the UE 105 using a pre-shared uplink timing configuration provided by the source base station 110 earlier in the communication process. The uplink timing configuration may ensure that the UE 105 is prepared with the necessary timing information to align transmissions with uplink timing of the target base station 110, which can decrease a time required for the handover.

As shown at step 12, the source base station 110 may provide an early status transfer message to the target base station 110. For example, the early status transfer message may indicate that the user data from the UPF will be transferred to the target base station 110. In some implementations, the early status transfer message provided to the target base station 110 may include additional context such as QoS requirements or active session details to further facilitate seamless data forwarding. As shown at step 13, the source base station 110 may receive the user data from the UPF, and may provide the user data to the target base station 110 based on the early status transfer. For example, the source base station 110 may request the user data from the UPF and may forward the user data to the target base station 110. The target base station 110 may receive the user data and may utilize the user data to provide an improved handover for the UE 105.

As shown at step 14, the UE 105 may evaluate the CLTM execution conditions. If the CLTM execution conditions are satisfied, the UE 105 may determine to perform a handover from the source base station 110 to the target base station 110. For example, the UE 105 may rely solely on Layer 3 measurements for evaluating the CLTM execution conditions, and may not rely on Layer 1 measurements for evaluating the CLTM execution conditions. By depending exclusively on Layer 3 measurements, the UE 105 may simplify the decision-making process and potentially reduce computational overhead and power consumption. Additionally, or alternatively, the decision by the UE 105 to perform a handover may be based on predictive models that anticipate the satisfaction of CLTM execution conditions, rather than waiting for the CLTM execution conditions to be satisfied. This proactive approach may result in even more efficient handovers, as the UE 105 can initiate the handover process before the network conditions decline below certain thresholds, avoiding service degradation.

As shown at step 15, the UE 105 may perform a CLTM decision by detaching from the source base station 110 and applying the target base station 110 configuration. For example, the UE 105 may detach from the source base station 110 and may apply the configuration associated with the target base station 110 in order to transition from the source base station 110 to the target base station 110.

As shown at step 16, the UE 105 may perform a random access control channel (RACH) procedure with the target base station 110. For example, the UE 105 may perform the RACH procedure with the target base station 110 if uplink timing advance acquisition was not previously available. In some implementations, if the RACH procedure is not required, the UE 105 may perform a direct transition to the target base station 110 using an alternative method. This could further streamline the handover process by enabling the UE 105 to seamlessly switch to the target base station 110 based on existing connections. Additionally, or alternatively, in the event that CLTM handover to the target base station 110 is not viable, the UE 105 may revert to connecting with one of the other target base stations 110 as identified in the handover request provided in the RRC reconfiguration message. This fallback mechanism may ensure continuity of the service for the UE 105 even when the target base station 110 is not reachable.

As shown at step 17, the UE 105 may complete the CLTM handover to the target base station 110. For example, once the UE 105 transitions to the target base station 110, the CLTM handover may be complete. As shown at step 18, the source base station 110 may receive a handover success message from the target base station 110. For example, the target base station 110 may generate the handover success message once the CLTM handover is complete. The target base station 110 may provide the handover success message to the source base station 110, and the source base station 110 may receive the handover success message from the target base station 110. In some implementations, the source base station 110 may utilize an alternative mechanism for confirming handover success, such as direct feedback from the UE 105 post-handover or monitoring network quality metrics after the handover. This may provide a reliable confirmation that the UE 105 has successfully handed over and is operating with the new target base station 110 configuration. Additionally, or alternatively, upon successful handover, the source base station 110 may instruct other network elements to update routing tables and resource allocations based on the new location of the UE 105.

As shown at step 19, the source base station 110 may provide a late status transfer message to the target base station 110. For example, the late status transfer message may indicate that the user data from the UPF will be transferred to the target base station 110. In some implementations, the late status transfer message provided to the target base station 110 may include additional context such as QoS requirements or active session details to further facilitate seamless data forwarding. As shown at step 20, the source base station 110 may receive the user data from the UPF, and may provide the user data to the target base station 110 based on the late status transfer. For example, the source base station 110 may request the user data from the UPF and may forward the user data to the target base station 110. The target base station 110 may receive the user data and may utilize the user data.

As shown at step 21, the source base station 110 may provide a handover cancel message to the other target base stations 110. For example, once the UE 105 is handed over to the target base station 110, the other target base stations 110 need not prepare for a handover of the UE 105. Thus, the source base station may generate the handover cancel message, and may provide the handover cancel message to the other target base stations 110.

FIG. 1D depicts an example information flow diagram associated with providing intra-base station conditional triggered mobility for the UE 105. In a 5G New Radio (NR) system, a network node, a network entity, a mobility element of a network, a radio access network (RAN) node, a core network node, a network element, a base station, or a network equipment may be implemented in an aggregated or disaggregated architecture. For example, a base station (such as a Node B (NB), evolved NB (eNB), NR BS, 5G NB, gNodeB (gNB), access point (AP), transmit receive point (TRP), or cell), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more central units (CUs), one or more distributed units (DUs), one or more radio units (RUs), or a combination thereof). A CU may be responsible for non-real-time RRC protocol stack functions. A DU may be deployed close to an RU on site and may execute a radio link control (RLC), a media access control (MAC) protocol, and parts of the physical layer. An RU may covert radio signals sent to and from an antenna into a digital signal for transmission over packet networks.

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as one or more CUs, one or more DUs, or one or more RUs). In some implementations, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also may be implemented as virtual units (e.g., a virtual central unit (VCU), a virtual distributed unit (VDU), or a virtual radio unit (VRU)). A disaggregated base station may include functionality implemented across two or more units at various physical locations, as well as functionality implemented for at least one unit virtually, which may enable flexibility in network design. The various units of the disaggregated base station may be configured for wired or wireless communication with at least one other unit of the disaggregated base station.

As shown at step 1 of FIG. 1D, the UE 105, a DU of a base station 110, and a CU of the base station 110 may exchange L3 measurement control and reports. For example, the DU and the CU may collect L3 measurements associated with the UE 105 to facilitate monitoring and assessing the communication and reception characteristics of the UE 105. In some implementations, the measurement control and reports may include L1 measurement control and reports, in addition to the L3 measurements. The L1 measurements (e.g., signal timing and frequency properties) may further refine handover decisions by providing detailed insights into a current radio environment experienced by the UE 105. This additional data may complement the L3 measurements, contributing to a more comprehensive understanding of a connection status of the UE 105 and ensuring that handover decisions are made with maximal accuracy and efficiency.

As shown at step 2, the CU may determine a CLTM configuration decision to hand over the UE 105 to the CU. For example, the CU may determine the CLTM configuration decision to hand over the UE 105 to the CU based on the L3 measurements. Additionally, or alternatively, the CLTM configuration decision may be based on a combination of the L1 measurements and the L3 measurements for enhanced accuracy in the handover decision. The combination of the L1 measurements and the L3 measurements provides the CU with a more nuanced view of a signal environment of the UE 105, enabling a more accurate assessment of when handover might be necessary.

As shown at step 3, the CU may provide a UE context modification request to the DU. For example, the UE context modification request may include a request for to the DU to modify the context of the UE 105 from the DU to the CU. Additionally, or alternatively, the UE context modification request may include changes to the handover execution conditions of the UE 105. The changes to the handover execution conditions may include adjustments to existing handover criteria or a specification of particular synchronization signals required for interaction with the CU.

As shown at step 4, the CU may receive, from the DU, a UE context modification response to the UE context modification request. For example, the UE context modification response may include information indicating that the DU modified the context of the UE 105 from the DU to the CU. Additionally, or alternatively, the UE context modification response may include a request for modified configurations relevant to early downlink synchronization and timing advance (TA) acquisition.

As shown at step 5, the CU may provide a downlink RRC message transfer (e.g., an RRC reconfiguration) to the DU. For example, the downlink RRC message transfer may include an RRC reconfiguration to be implemented by the UE 105 and a handover request for the UE 105 to handover the UE 105 from the DU to the CU. Additionally, or alternatively, the downlink RRC message transfer may include additional information, such as an identifier of the CU. The identifier of the CU may provide the UE 105 with instructions about the CU, thereby providing a seamless handover.

As shown at step 6, the DU may provide the RRC reconfiguration to the UE 105 for implementation. For example, the UE 105 may receive the RRC reconfiguration, and may implement the RRC reconfiguration. In some implementations, the RRC reconfiguration may include information that enables features such, such as a candidate frequency search or a configured grant random access channel (CFRA), an LTM configuration, a measurement configuration, and a CHO-related configuration. These features may ensure that the UE 105 is equipped with specific instructions and configurations that address different handover scenarios.

As shown at step 7, the DU may receive an RRC reconfiguration complete message from the UE 105. For example, when the UE 105 implements the RRC reconfiguration, the UE 105 may generate the RRC reconfiguration complete message indicating that the UE 105 has implemented the RRC reconfiguration. In some implementations, the RRC reconfiguration complete message may indicate whether the UE 105 has achieved downlink synchronization with the CU.

As shown at step 8, the DU may provide an uplink RRC message transfer (e.g., RRC reconfiguration complete) to the CU. For example, the DU may generate the uplink RRC message transfer based on receiving the RRC reconfiguration complete message from the UE 105. The uplink RRC message transfer may indicate that the UE 105 has implemented the RRC reconfiguration. As shown at step 9, the DU may perform an early TA acquisition with the UE 105. For example, the early TA acquisition may include the DU requesting, from the UE 105, timing information associated with the UE 105.

As shown at step 10, the UE 105 may determine L1 or L3 measurements. For example, in response to the DU requesting the timing information, the UE 105 may generate the L1 or L3 measurements. The L1 or L3 measurements may include timing information associated with the UE 105. The UE 105 may also evaluate the CLTM execution conditions. If the CLTM execution conditions are satisfied, the UE 105 may determine to perform a handover from the DU to the CU. For example, the UE 105 may rely solely on Layer 3 measurements for evaluating the CLTM execution conditions, and may not rely on Layer 1 measurements for evaluating the CLTM execution conditions. By depending exclusively on Layer 3 measurements, the UE 105 may simplify the decision-making process and potentially reduce computational overhead and power consumption. Additionally, or alternatively, the decision by the UE 105 to perform a handover may be based on predictive models that anticipate the satisfaction of CLTM execution conditions, rather than waiting for the CLTM execution conditions to be satisfied.

As shown at step 11, the UE 105 may determine an intercell mobility decision to hand over the UE 105 from the DU to the CU. For example, the UE 105 may perform the intercell mobility decision by detaching from the DU and applying the CU configuration. For example, the UE 105 may detach from the DU and may apply the configuration associated with the CU in order to transition from the DU to the CU.

As shown at step 12, the UE 105 may alternatively perform a RACH procedure with the CU. For example, the UE 105 may perform the RACH procedure with the CU if uplink timing advance acquisition was not previously available. In some implementations, if the RACH procedure is not required, the UE 105 may perform a direct transition to the CU using an alternative method. As shown at steps 13 and 14, the DU may detect access by the UE 105, and may provide an access success message (e.g., with the target cell ID) to the CU. For example, when the UE 105 accesses the DU, the DU may detect the access by the UE 105, and may generate the access success message indicating that the target cell ID and that the UE 105 has successfully accessed the DU. The CU may receive the access success message from the DU.

As shown at step 15, the DU may receive an RRC reconfiguration complete message from the UE 105. For example, when the UE 105 accesses the DU, the UE 105 may generate the RRC reconfiguration complete message indicating that the UE 105 has implemented the RRC reconfiguration. The UE 105 may provide the RRC reconfiguration complete message to the DU. As shown at step 16, the DU may provide an uplink RRC message transfer (e.g., indicating completion of the RRC reconfiguration) to the CU. For example, the DU may generate the uplink RRC message transfer based on receiving the RRC reconfiguration complete message from the UE 105. The uplink RRC message transfer may indicate that the UE 105 has implemented the RRC reconfiguration.

As shown at step 17, the DU may receive a UE context modification request (e.g., indicating prepared cells and resources to be released) from the CU. For example, when the CU receives the uplink RRC message transfer from the DU, the CU may generate the UE context modification request indicating that DU is to modify context of the UE 105 from the DU to the CU, as indicated by the prepared cells and resources to be released. The CU may provide the UE context modification request to the DU. As shown at step 18, the DU may provide a UE context modification response to the CU and based on the UE context modification request. For example, when the DU modifies the context of the UE 105 from the DU to the CU, the DU may generate the UE context modification response indicating that the DU has modified the context of the UE 105 from the DU to the CU. The CU may receive the UE context modification response from the DU. As shown at step 19, user data may be exchanged between the UE 105 and the CU. For example, once the context of the UE 105 has been modified from the DU to the CU, the UE 105 and the CU may exchange user data.

FIGS. 1E and 1F depict an example information flow diagram associated with providing inter-base station conditional triggered mobility for the UE 105. In the example of FIGS. 1E and 1F, a source DU of a base station 110, a target DU of another base station 110, and a CU of both base stations 110 may be provided. As shown at step 1, the UE 105, the source DU, the target DU, and the CU may exchange L3 measurement control and reports. For example, the source DU, the target DU, and the CU may collect L3 measurements associated with the UE 105 to facilitate monitoring and assessing the communication and reception characteristics of the UE 105. In some implementations, the measurement control and reports may include L1 measurement control and reports, in addition to the L3 measurements. The L1 measurements (e.g., signal timing and frequency properties) may further refine handover decisions by providing detailed insights into a current radio environment experienced by the UE 105. This additional data may complement the L3 measurements, contributing to a more comprehensive understanding of a connection status of the UE 105 and ensuring that handover decisions are made with maximal accuracy and efficiency.

As shown at step 2, the CU may determine an LTM decision to hand over the UE 105 from the source DU to the target DU. For example, the CU may determine the LTM configuration decision to hand over the UE 105 from the target DU to the source DU based on the L3 measurements. Additionally, or alternatively, the LTM configuration decision may be based on a combination of the L1 measurements and the L3 measurements for enhanced accuracy in the handover decision. The combination of the L1 measurements and the L3 measurements provides the CU with a more nuanced view of a signal environment of the UE 105, enabling a more accurate assessment of when handover might be necessary.

As shown at step 3, the target DU may receive a UE context setup request from the CU. For example, based on the LTM configuration decision, the CU may generate the UE context setup request, and may provide the UE context setup request to the target DU. In some implementations, the UE context setup request may include specific radio frequency parameters or historical performance data, which may enable the target DU to better tailor resources and configuration to accommodate the UE 105.

As shown at step 4, the target DU may provide a UE context setup response to the CU and based on the UE context setup request. For example, the target DU may set up the context for the UE 105 based on the UE context setup request, and may generate the UE context setup response indicating that the context for the UE 105 is set up. The CU may receive the UE context setup response from the target DU. In some implementations, the UE context setup response may include a predictive analysis of expected movements of the UE 105, enabling proactive adjustments to network configurations.

As shown at step 5, the CU may provide a UE context modification request to the source DU. For example, the UE context modification request may include a request for to the source DU to modify the context of the UE 105 from the source DU to the target DU. Additionally, or alternatively, the UE context modification request may include changes to the handover execution conditions of the UE 105. The changes to the handover execution conditions may include adjustments to existing handover criteria or a specification of particular synchronization signals required for interaction with the target DU. In some implementations, the UE context modification request may include additional parameters for optimizing handover in specific service scenarios, like high-speed travel or dense urban environments.

As shown at step 6, the CU may receive, from the source DU, a UE context modification response to the UE context modification request. For example, the UE context modification response may include information indicating that the source DU modified the context of the UE 105 from the source DU to the target DU. Additionally, or alternatively, the UE context modification response may include a request for modified configurations relevant to early downlink synchronization and TA acquisition.

As shown at step 7, the CU may provide a UE context modification request to the target DU. For example, the UE context modification request may include a request for to the target DU to modify the context of the UE 105 from the source DU to the target DU. Additionally, or alternatively, the UE context modification request may include changes to the handover execution conditions of the UE 105. The changes to the handover execution conditions may include adjustments to existing handover criteria or a specification of particular synchronization signals required for interaction with the target DU.

As shown at step 8, the CU may receive, from the target DU, a UE context modification response to the UE context modification request. For example, the UE context modification response may include information indicating that the target DU modified the context of the UE 105 from the source DU to the target DU. Additionally, or alternatively, the UE context modification response may include a request for modified configurations relevant to early downlink synchronization and TA acquisition. In some implements, the UE context modification response may include contingency plans for unexpected changes in UE behavior or network conditions.

As shown at step 9, the CU may provide a downlink RRC message transfer (e.g., an RRC reconfiguration) to the source DU. For example, the downlink RRC message transfer may include an RRC reconfiguration to be implemented by the UE 105 and a handover request for the UE 105 to hand over from the source DU to the target DU. Additionally, or alternatively, the downlink RRC message transfer may include additional information, such as an identifier of the target DU. The identifier of the target DU may provide the UE 105 with instructions about the target DU, thereby providing a seamless handover.

As shown at step 10, the source DU may provide the RRC reconfiguration to the UE 105 for implementation. For example, the UE 105 may receive the RRC reconfiguration, and may implement the RRC reconfiguration. In some implementations, the RRC reconfiguration may include information that enables features such, such as a candidate frequency search or a CFRA channel, an LTM configuration, a measurement configuration, and a CHO-related configuration. These features may ensure that the UE 105 is equipped with specific instructions and configurations that address different handover scenarios. In some implementations, the RRC reconfiguration may include fallback or alternative configurations.

As shown at step 11, the source DU may receive an RRC reconfiguration complete message from the UE 105. For example, when the UE 105 implements the RRC reconfiguration, the UE 105 may generate the RRC reconfiguration complete message indicating that the UE 105 has implemented the RRC reconfiguration. In some implementations, the RRC reconfiguration complete message may indicate whether the UE 105 has achieved downlink synchronization with the target DU.

As shown at step 12, the source DU may provide an uplink RRC message transfer (e.g., RRC reconfiguration complete) to the CU. For example, the source DU may generate the uplink RRC message transfer based on receiving the RRC reconfiguration complete message from the UE 105. The uplink RRC message transfer may indicate that the UE 105 has implemented the RRC reconfiguration. In some implementations, the transfer can be encoded with priority indicators, enhancing the efficiency of processing the handover-related messages by the CU.

As shown at step 13, the target DU may perform an early TA acquisition with the UE 105. For example, the early TA acquisition may include the target DU requesting, from the UE 105, timing information associated with the UE 105. As shown at step 14, the target DU may provide a DU-CU TA information transfer to the CU. For example, the target DU may provide the timing information associated with the UE 105 to the CU. As shown at step 15, the source DU may receive CU-DU TA information transfer from the CU. For example, the CU may provide the timing information associated with the 105 to the source DU. In some implementations, the transfer may include suggestions for resource reallocation or network traffic management by the source DU.

As shown at step 16, the UE 105 may determine L1 or L3 measurements. For example, in response to the DU requesting the timing information, the UE 105 may generate the L1 or L3 measurements. The L1 or L3 measurements may include timing information associated with the UE 105. The UE 105 may also evaluate the CLTM execution conditions. If the CLTM execution conditions are satisfied, the UE 105 may determine to perform a handover from the DU to the CU. For example, the UE 105 may rely solely on Layer 3 measurements for evaluating the CLTM execution conditions, and may not rely on Layer 1 measurements for evaluating the CLTM execution conditions. By depending exclusively on Layer 3 measurements, the UE 105 may simplify the decision-making process and potentially reduce computational overhead and power consumption. Additionally, or alternatively, the decision by the UE 105 to perform a handover may be based on predictive models that anticipate the satisfaction of CLTM execution conditions, rather than waiting for the CLTM execution conditions to be satisfied.

As shown at step 17, the UE 105 may determine a CLTM cell switch decision to hand over the UE 105 from the source DU to the target DU. For example, the UE 105 may determine the CLTM cell switch decision based on the L1 or L3 measurements. In some implementations, the CLTM cell switch decision may include a decision to hand over the UE 105 from the source DU to the target DU.

As shown at step 18 of FIG. 1F, the target DU may receive CU-DU cell switch notification (e.g., with the target cell ID and the TCI state ID) from the CU. For example, the CU-DU cell switch notification may include the target cell ID and the TCI state ID and may enable the target DU to become apprised of an impending handover and to prepare accordingly by ensuring the appropriate configurations are in place for the UE 105.

As shown at step 19, the UE 105 may alternatively perform a RACH procedure with the target DU. For example, the UE 105 may perform the RACH procedure with the target DU if uplink timing advance acquisition was not previously available. In some implementations, if the RACH procedure is not required, the UE 105 may perform a direct transition to the target DU using an alternative method.

As shown at steps 20 and 21, the target DU may detect access by the UE 105, and may provide an access success message (e.g., with a target cell ID) to the CU. For example, when the UE 105 accesses the target DU, the DU may detect the access by the UE 105, and may generate the access success message indicating the target cell ID and the TCI state ID and that the UE 105 has successfully accessed the target DU. The CU may receive the access success message from the DU. Properly detecting the access of the UE 105 enables the target DU to proceed with subsequent steps. The access success message may confirm to the CU that the UE 105 has successfully accessed the target DU, which enables further processes like data transfer and synchronization to take place effectively.

As shown at step 22, the target DU may receive an RRC reconfiguration complete message from the UE 105. For example, the RRC reconfiguration complete message from the UE 105 may confirm, to the target DU, that the UE 105 has accomplished the necessary reconfiguration to operate within the parameters of the target DU, thus moving the handover process into its final stages. In some implementations, receiving the RRC reconfiguration complete message may include additional details such as QoS parameters or signal quality metrics post-handover. Including such details in the message can provide the target DU and the CU with more comprehensive information about the post-handover status of the UE 105.

As shown at step 23, the target DU may provide an uplink RRC message transfer (e.g., indicating completion of the RRC reconfiguration) to the CU. For example, the uplink RRC message transfer may indicate the completion of the RRC reconfiguration by the UE 105, thereby enabling the CU to update records and acknowledge the successful handover. In some implementations, the uplink RRC message transfer may implement a verification protocol to reduce the risk of miscommunication and ensure that both the target DU and the CU are synchronized in handover procedures.

As shown at step 24, the source DU may receive a UE context release command (e.g., indicating prepared cells and resources to be released) from the CU. For example, the context release command may include indications of which prepared cells and resources are to be released as a part of the handover procedure, clearly delineating the cells that are no longer required be the UE 105. In some implementations, in lieu of the UE context release command, the source DU may initiate a pre-emptive context preservation process in anticipation of handover request success. This process would allow the source DU to temporarily preserve the context of the UE 105, minimizing any potential service interruption in case of handover failure, and smoothly transitioning context upon confirmation of successful handover.

As shown at step 25, the source DU may provide a UE context release complete message to the CU. For example, the UE context release complete message may inform the CU that the source side of the handover process is complete and that the source DU has released the context and resources associated with the UE 105. In some implementations, the UE context release complete message may include details of resource reallocation for released cells and resources. By providing such details, the message acts as an audit trail for the handover, allowing the CU to track the allocation and deallocation of network resources during the handover.

As shown at step 26, user data may be exchanged between the UE 105, the target DU, and the CU. For example, the exchange of the user data between the UE 105, the target DU, and the CU may indicate that ongoing and uninterrupted communication services have been maintained for the UE 105, even as the UE 105 transitions between coverage areas in the network.

In this way, a source network device provides conditional triggered mobility for a UE 105. For example, the source network device may enhance handover reliability and reduce handover latency/interruption time in telecommunications networks. The source network device may receive measurement data from a UE 105 and may generate handover conditions based on the measurement data. The source network device may provide a handover request, including an identifier of a target network device, to initiate handover without radio access channel procedures. The source network device may apply a targeted configuration to the UE 105, incorporating both Layer 1 and Layer 3 measurements specific to the target network device. The source network device may enable early downlink and uplink synchronization, as well as timing advance acquisition with the target network device before the handover. By ensuring a more efficient handover procedure, a network may provide consistent service quality required by latency-sensitive applications, and may accommodate a higher volume of such high-quality connectivity demands without additional resources.

Thus, the source network device may conserve computing resources, networking resources, and/or other resources that would have otherwise been consumed by failing to optimize both handover latency and handover reliability for UEs 105 utilizing the services that demand high throughput, low latency, and high reliability, failing to address the handover process in different network configurations (e.g., a aggregated base station handovers, intra-base station handovers, inter-base station handovers, disaggregated base station handovers, and/or the like), handling poor user experiences based on failing to optimize both handover latency and handover reliability for UEs 105 utilizing the services that demand high throughput, low latency, and high reliability, and/or the like.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

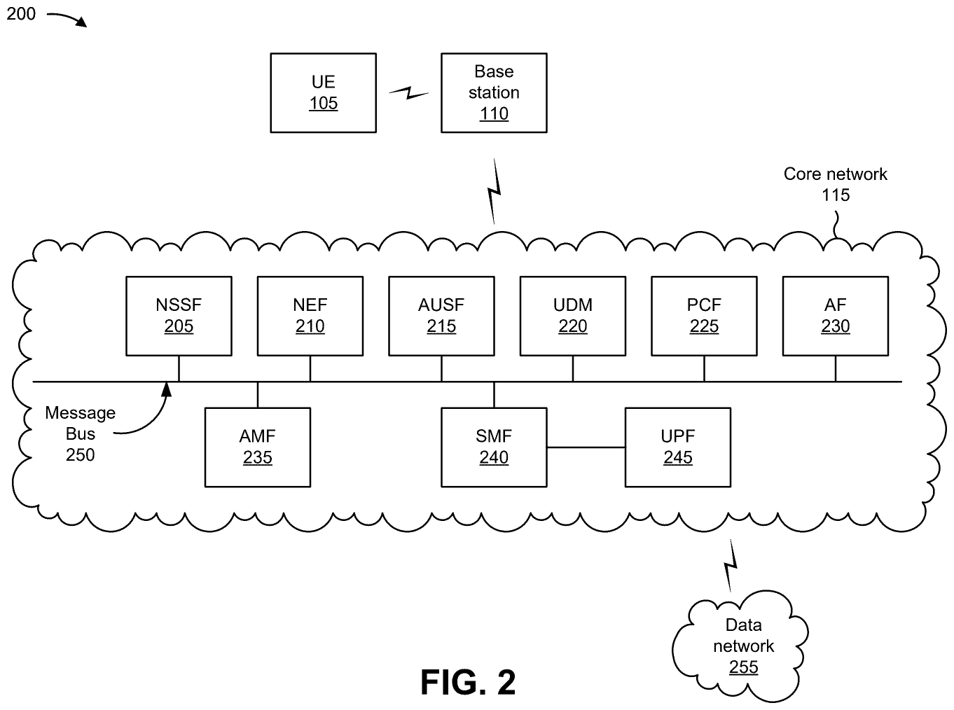

FIG. 2 is a diagram of an example environment 200 in which systems and/or methods described herein may be implemented. As shown in FIG. 2, the example environment 200 may include the UE 105, a base station 110, the core network 115, and a data network 255. Devices and/or networks of the example environment 200 may interconnect via wired connections, wireless connections, or a combination of wired and wireless connections.

The UE 105 includes one or more devices capable of receiving, generating, storing, processing, and/or providing information, such as information described herein. For example, the UE 105 may include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The base station 110 may support, for example, a cellular radio access technology (RAT). The base station 110 may include one or more base stations (e.g., base transceiver stations, radio base stations, node Bs, eNodeBs (eNBs) (e.g., the 4G base station 110), gNodeBs (gNBs) (e.g., the 5G base stations 110-1 and 110-2), base station subsystems, cellular sites, cellular towers, access points, TRPs, radio access nodes, macrocell base stations, microcell base stations, picocell base stations, femtocell base stations, or similar types of devices) and other network entities that can support wireless communication for the UE 105. The base station 110 may transfer traffic between the UE 105 (e.g., using a cellular RAT), one or more base stations (e.g., using a wireless interface or a backhaul interface, such as a wired backhaul interface), and/or the core network 115. The base station 110 may provide one or more cells that cover geographic areas.

In some implementations, the base station 110 may perform scheduling and/or resource management for the UE 105 covered by the base station 110 (e.g., the UE 105 covered by a cell provided by the base station 110). In some implementations, the base station 110 may be controlled or coordinated by a network controller, which may perform load balancing, network-level configuration, and/or other operations. The network controller may communicate with the base station 110 via a wireless or wireline backhaul. In some implementations, the base station 110 may include a network controller, a self-organizing network (SON) module or component, or a similar module or component. In other words, the base station 110 may perform network control, scheduling, and/or network management functions (e.g., for uplink, downlink, and/or sidelink communications of the UE 105 covered by the base station 110).

In some implementations, the core network 115 may include an example functional architecture in which systems and/or methods described herein may be implemented. For example, the core network 115 may include an example architecture of a fifth generation (5G) next generation (NG) core network included in a 5G wireless telecommunications system. While the example architecture of the core network 115 shown in FIG. 2 may be an example of a service-based architecture, in some implementations, the core network 115 may be implemented as a reference-point architecture and/or a 4G core network, among other examples.

As shown in FIG. 2, the core network 115 may include a number of functional elements. The functional elements may include, for example, a network slice selection function (NSSF) 205, a network exposure function (NEF) 210, an authentication server function (AUSF) 215, a unified data management (UDM) component 220, a policy control function (PCF) 225, an application function (AF) 230, an AMF 235, a session management function (SMF) 240, and/or a UPF 245. These functional elements may be communicatively connected via a message bus 250. Each of the functional elements shown in FIG. 2 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 205 includes one or more devices that select network slice instances for the UE 105. By providing network slicing, the NSSF 205 allows an operator to deploy multiple substantially independent end-to-end networks potentially with the same infrastructure. In some implementations, each slice may be customized for different services.

The NEF 210 includes one or more devices that support exposure of capabilities and/or events in the wireless telecommunications system to help other entities in the wireless telecommunications system discover network services.

The AUSF 215 includes one or more devices that act as an authentication server and support the process of authenticating the UE 105 in the wireless telecommunications system.

The UDM 220 includes one or more devices that store user data and profiles in the wireless telecommunications system. The UDM 220 may be used for fixed access and/or mobile access in the core network 115.

The PCF 225 includes one or more devices that provide a policy framework that incorporates network slicing, roaming, packet processing, and/or mobility management, among other examples.

The AF 230 includes one or more devices that support application influence on traffic routing, access to the NEF 210, and/or policy control, among other examples.

The AMF 235 includes one or more devices that act as a termination point for non-access stratum (NAS) signaling and/or mobility management, among other examples.

The SMF 240 includes one or more devices that support the establishment, modification, and release of communication sessions in the wireless telecommunications system. For example, the SMF 240 may configure traffic steering policies at the UPF 245 and/or may enforce user equipment Internet protocol (IP) address allocation and policies, among other examples.

The UPF 245 includes one or more devices that serve as an anchor point for intraRAT and/or interRAT mobility. The UPF 245 may apply rules to packets, such as rules pertaining to packet routing, traffic reporting, and/or handling user plane QoS, among other examples.

The message bus 250 represents a communication structure for communication among the functional elements. In other words, the message bus 250 may permit communication between two or more functional elements.

The data network 255 includes one or more wired and/or wireless data networks. For example, the data network 255 may include an IP Multimedia Subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the example environment 200 may perform one or more functions described as being performed by another set of devices of the example environment 200.

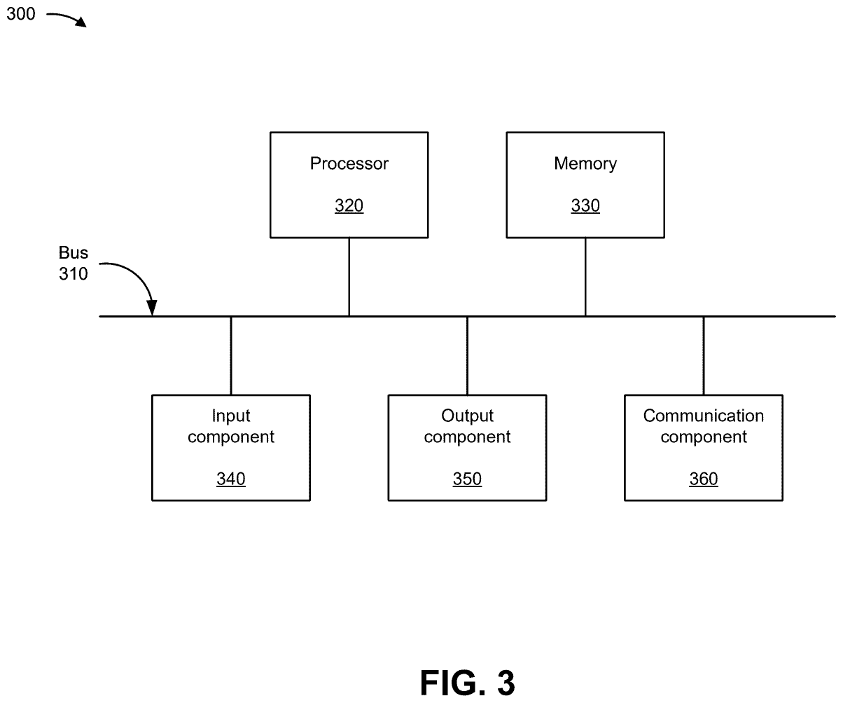

FIG. 3 is a diagram of example components of a device 300, which may correspond to the UE 105, the base station 110, the NSSF 205, the NEF 210, the AUSF 215, the UDM 220, the PCF 225, the AF 230, the AMF 235, the SMF 240, and/or the UPF 245. In some implementations, the UE 105, the base station 110, the NSSF 205, the NEF 210, the AUSF 215, the UDM 220, the PCF 225, the AF 230, the AMF 235, the SMF 240, and/or the UPF 245 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection).

The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein.

For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

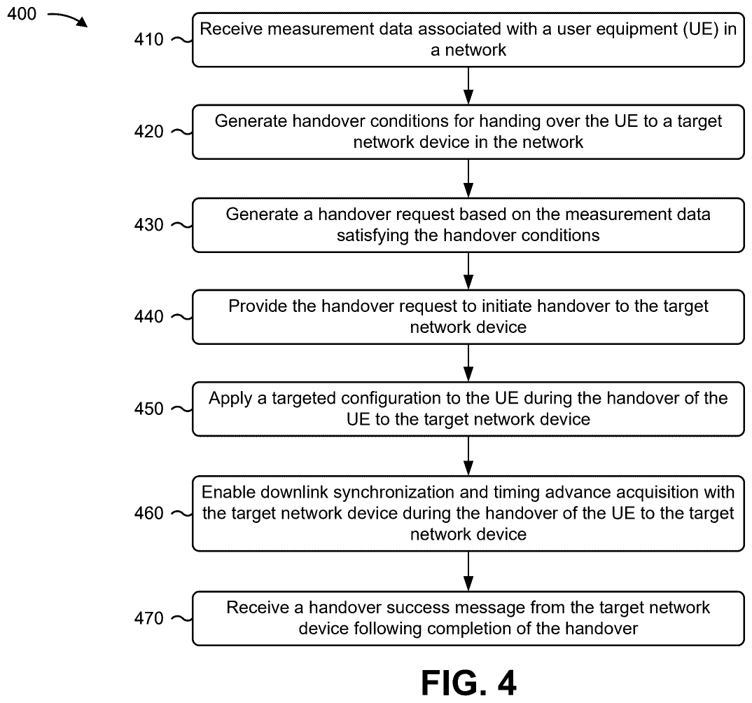

FIG. 4 is a flowchart of an example process 400 for providing conditional triggered mobility for a UE. In some implementations, one or more process blocks of FIG. 4 may be performed by a network device (e.g., the base station 110). In some implementations, one or more process blocks of FIG. 4 may be performed by another device or a group of devices separate from or including the network device, such as a component (e.g., a DU, a CU, and/or the like) of a base station 110. Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving measurement data associated with a UE in a network (block 410). For example, the source network device may receive measurement data associated with a UE in a network, as described above. In some implementations, the measurement data associated with the UE includes Layer 3 measurement data.

As further shown in FIG. 4, process 400 may include generating handover conditions for handing over the UE to a target network device in the network (block 420). For example, the source network device may generate handover conditions for handing over the UE to a target network device in the network, as described above. In some implementations, the handover conditions include configurations for downlink synchronization, uplink synchronization, and timing advance acquisition for the target network device. In some implementations, each of the source network device and the target network device is a base station. In some implementations, the handover conditions include downlink transmission channel information state activation for the target network device. In some implementations, the handover conditions include uplink timing advance acquisition for the target network device and to enable the UE to align transmission with a timing of the target network device.

As further shown in FIG. 4, process 400 may include generating a handover request based on the measurement data satisfying the handover conditions (block 430). For example, the source network device may generate a handover request based on the measurement data satisfying the handover conditions, as described above. In some implementations, the handover request includes an identifier of the target network device and enables handover without requiring radio access channel procedures.

As further shown in FIG. 4, process 400 may include providing the handover request to initiate handover to the target network device (block 440). For example, the source network device may provide the handover request to initiate handover to the target network device, as described above. In some implementations, providing the handover request to initiate handover to the target network device includes providing, with the handover request, early synchronization signals and a timing configuration for the target network device.

As further shown in FIG. 4, process 400 may include applying a targeted configuration to the UE before the handover of the UE to the target network device (block 450). For example, the source network device may apply a targeted configuration to the UE before the handover of the UE to the target network device, as described above. In some implementations, the targeted configuration is derived from Layer 1 and Layer 3 measurements specific to the target network device.

As further shown in FIG. 4, process 400 may include enabling downlink synchronization and timing advance acquisition with the target network device before the handover of the UE to the target network device (block 460). For example, the source network device may enable downlink synchronization and timing advance acquisition with the target network device before the handover of the UE to the target network device, as described above.

As further shown in FIG. 4, process 400 may include receiving a handover success message from the target network device following completion of the handover (block 470). For example, the source network device may receive a handover success message from the target network device following completion of the handover, as described above. In some implementations, the handover success message confirms application of the targeted configuration to the UE and initiates a transfer of data associated with the UE to the target network device.

In some implementations, process 400 includes releasing resources associated with the UE based on receiving the handover success message. In some implementations, process 400 includes canceling handover processes with other target network devices based on receiving the handover success message. In some implementations, process 400 includes providing an early status transfer message to the target network device for preemptive data forwarding to the UE.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either”or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a source network device, measurement data associated with a user equipment (UE) in a network;
generating, by the source network device, handover conditions for handing over the UE to a target network device in the network;
generating, by the source network device, a handover request based on the measurement data satisfying the handover conditions;
providing, by the source network device, the handover request to initiate handover to the target network device;
applying, by the source network device, a targeted configuration to the UE before the handover of the UE to the target network device;
enabling, by the source network device, downlink synchronization and timing advance acquisition with the target network device before the handover of the UE to the target network device; and
receiving, by the source network device, a handover success message from the target network device following completion of the handover.

2. The method of claim 1, wherein the handover conditions include configurations for downlink synchronization, uplink synchronization, and timing advance acquisition for the target network device.

3. The method of claim 1, wherein the handover request includes an identifier of the target network device and enables handover.

4. The method of claim 1, wherein the targeted configuration is derived from Layer 1 and Layer 3 measurements specific to the target network device.

5. The method of claim 1, wherein the handover success message confirms application of the targeted configuration to the UE and initiates a transfer of data associated with the UE to the target network device.

6. The method of claim 1, wherein the measurement data associated with the UE includes Layer 3 measurement data.

7. The method of claim 1, wherein providing the handover request to initiate handover to the target network device comprises:
providing, with the handover request, synchronization signals and a timing configuration for the target network device.

8. A source network device, comprising:
one or more processors configured to:
receive measurement data associated with a user equipment (UE) in a network;
generate handover conditions for handing over the UE to a target network device in the network;
generate a handover request based on the measurement data satisfying the handover conditions,
wherein the handover request includes an identifier of the target network device and enables handover;
provide the handover request to initiate handover to the target network device;
apply a targeted configuration to the UE before the handover of the UE to the target network device;
enable downlink synchronization and timing advance acquisition with the target network device before the handover of the UE to the target network device; and
receive a handover success message from the target network device following completion of the handover.

9. The source network device of claim 8, wherein the handover conditions include downlink transmission channel information state activation for the target network device.

10. The source network device of claim 8, wherein the handover conditions include uplink timing advance acquisition for the target network device and to enable the UE to align transmission with a timing of the target network device.

11. The source network device of claim 8, wherein the one or more processors are further configured to:
release resources associated with the UE based on receiving the handover success message.

12. The source network device of claim 8, wherein the one or more processors are further configured to:
cancel handover processes with other target network devices based on receiving the handover success message.

13. The source network device of claim 8, wherein the one or more processors are further configured to: provide a status transfer message to the target network device for preemptive data forwarding to the UE.

14. The source network device of claim 8, wherein each of the source network device and the target network device is a base station.

15. A non-transitory computer-readable medium storing a set of instructions, the set of instructions comprising:
one or more instructions that, when executed by one or more processors of a source network device, cause the source network device to:
receive measurement data associated with a user equipment (UE) in a network;
generate handover conditions for handing over the UE to a target network device in the network;
generate a handover request based on the measurement data satisfying the handover conditions;
provide the handover request to initiate handover to the target network device;
apply a targeted configuration to the UE before the handover of the UE to the target network device;
enable downlink synchronization and timing advance acquisition with the target network device before the handover of the UE to the target network device;
receive a handover success message from the target network device following completion of the handover; and
release resources associated with the UE based on receiving the handover success message.

16. The non-transitory computer-readable medium of claim 15, wherein the handover conditions include configurations for downlink synchronization, uplink synchronization, and timing advance acquisition for the target network device.

17. The non-transitory computer-readable medium of claim 15, wherein the handover success message confirms application of the targeted configuration to the UE and initiates a transfer of data associated with the UE to the target network device.

18. The non-transitory computer-readable medium of claim 15, wherein the one or more instructions, that cause the source network device to provide the handover request to initiate handover to the target network device, cause the source network device to:
provide, with the handover request, synchronization signals and a timing configuration for the target network device.

19. The non-transitory computer-readable medium of claim 15, wherein the handover conditions include uplink timing advance acquisition for the target network device and to enable the UE to align transmission with a timing of the target network device.

20. The non-transitory computer-readable medium of claim 15, wherein the one or more instructions further cause the source network device to:
cancel handover processes with other target network devices based on receiving the handover success message.
